(19) United States
(12) Patent Application Publication
(10) Pub. No.: US 2019/0213492 A1
(43) Pub. Date: Jul. 11, 2019

(54) PREDICTING OUTCOME OF A SPORTING EVENT

(71) Applicant: Conor O. Neill, Liverpool (GB)

(72) Inventors: Conor O. Neill, Liverpool (GB); Eoin Kiersey, Dublin (IE)

(21) Appl. No.: 15/864,020

(22) Filed: Jan. 8, 2018

(51) Int. Cl. G06N 7/00; A63F 9/00

(52) U.S. Cl. CPC G06N 7/00; A63F 9/00

(57) ABSTRACT

A system and a method of predicting outcome of a sporting event are disclosed. The method comprises receiving a predicted outcome of a sporting event from at least one team. Each team comprises a plurality of individuals. Each of the individuals predicts the outcome of the sporting event. The method further comprises aggregating the predicted outcome received from each individual in a team to determine a team consensus prediction for the outcome of the sporting event. The method further comprises capturing an eventual outcome of the sporting event. The method further comprises comparing the eventual outcome with the team consensus predictions to identify and reward a team and the individuals predicting the eventual outcome.

### FIELD OF THE INVENTION

The present disclosure generally relates to predicting outcome of a sporting event. More particularly, the present disclosure relates a system and a method of predicting a sporting event as a group of users.

### DESCRIPTION OF RELATED ART

It is known that people try to predict the outcome of sporting events. The sporting events may include Soccer, American Football, Baseball, Basketball, Hockey, Soccer, Tennis, Golf, Olympic Events, Boxing, Bowling, Darts, Rugby, Cricket, eSports, Mixed Martial Arts, and so on. It is known that when at least two teams or individuals are competing, the outcome may include a win for a first team, or a win for a second team, or may end up in draw, e.g., a football game.

With advances in technology, people can predict the outcome of the sporting event from their homes. People may use their personal computers, smart phones and other electronic devices to predict the outcome by logging into a website. Several techniques have been proposed in existing art, which includes calculating predictions using algorithms based on player performance, relying on expert opinions, using a syndicate where a nominated captain predicts the outcome, analyzing the odds of a given outcome and so on to predict and reward the participants who predict the outcome accurately. However, there is no disclosure discussing about a method in which a group of participants can participate and predict the outcome of the sporting event.

### SUMMARY OF THE INVENTION

It is one of the main objects of the present invention to provide a system and a method for predicting the outcome of a sporting event as a group that avoids the drawbacks as known in the art.

In one aspect of the present disclosure, a method of predicting the outcome of a sporting event is disclosed. The method comprises receiving, by a processor, a predicted outcome of a sporting event from at least one team. The team comprises a plurality of individuals. Each of the individuals predicts the outcome of the sporting event. The method further comprises aggregating, by the processor, the predicted outcome received from each individual in the team to determine a team consensus prediction for the outcome of a given sporting event. The method further comprises capturing, by the processor, an eventual outcome of the sporting event. The method further comprises comparing, by the processor, the eventual outcome with the team consensus predictions to identify and reward the team and the individuals accurately predicting the eventual outcome.

In another aspect of the present invention, a system for predicting the outcome of a sporting event is disclosed. The system comprises a memory and a processor coupled to the memory. The processor is configured to execute program instructions stored in the memory to receive a predicted outcome of a sporting event from at least one team. The team comprises a plurality of individuals. Each of the individuals predicts the outcome of the sporting event. The processor is further configured to execute the program instructions stored in the memory to aggregate the predicted outcome received from each individual in the team to determine a team consensus prediction of the outcome of the sporting event. The processor is further configured to execute the program instructions stored in the memory to capture an eventual outcome of the sporting event. The processor is further configured to execute the program instructions stored in the memory to compare the eventual outcome with the team consensus predictions to determine the team and individuals accurately predicting the eventual outcome.

Further objects of the invention will be brought out in the following part of the specification, wherein a detailed description for the purpose of fully disclosing the invention without placing limitations thereon.

### BRIEF DESCRIPTION OF THE DRAWINGS

With the above and other related objects in view, the invention consists in the details of the construction and combination of parts as will be more fully understood from the following description, when read in conjunction with the accompanying drawings in which:

FIG. 1 illustrates a system for predicting outcome of a sporting event, in accordance with one embodiment of the present disclosure.

FIG. 2 depicts predicting score, in accordance with one exemplary embodiment of the present disclosure.

FIG. 3 depicts individual user predictions in a team, in accordance with one exemplary embodiment of the present disclosure.

FIG. 4 depicts comparing team consensus prediction of two teams, in accordance with one exemplary embodiment of the present disclosure.

FIG. 5 illustrates a method for predicting outcome of a sporting event, in accordance with one embodiment of the present disclosure.

### DETAILED DESCRIPTION OF THE INVENTION

The following detailed description is intended to provide example implementations to one of ordinary skill in the art, and is not intended to limit the invention to the explicit disclosure, as one or ordinary skill in the art will understand that variations can be substituted that are within the scope of the invention as described.

In the present disclosure, relational terms such as first and second, and the like, may be used to distinguish one entity from the other, without necessarily implying any actual relationship or order between such entities.

The present invention discloses a system and a method for predicting the outcome of a sporting event. The system allows individuals engaging in the act of predicting an outcome of a sporting event to predict as a group or team. Any number of individuals may form a team. The prediction by the team is considered as a team consensus prediction. The team consensus prediction is based on an aggregation of the individual predictions of each member. The team consensus prediction for the sporting event includes the predicted outcome/score of the sporting event along with a confidence rating. The confidence rating is based on the percentage of the individuals in the team who predicted the eventual outcome as the team consensus prediction.

While aspects of the proposed disclosure may be implemented in any number of different computing systems, environments, and/or configurations, the embodiments are described in the context of the following exemplary environment.

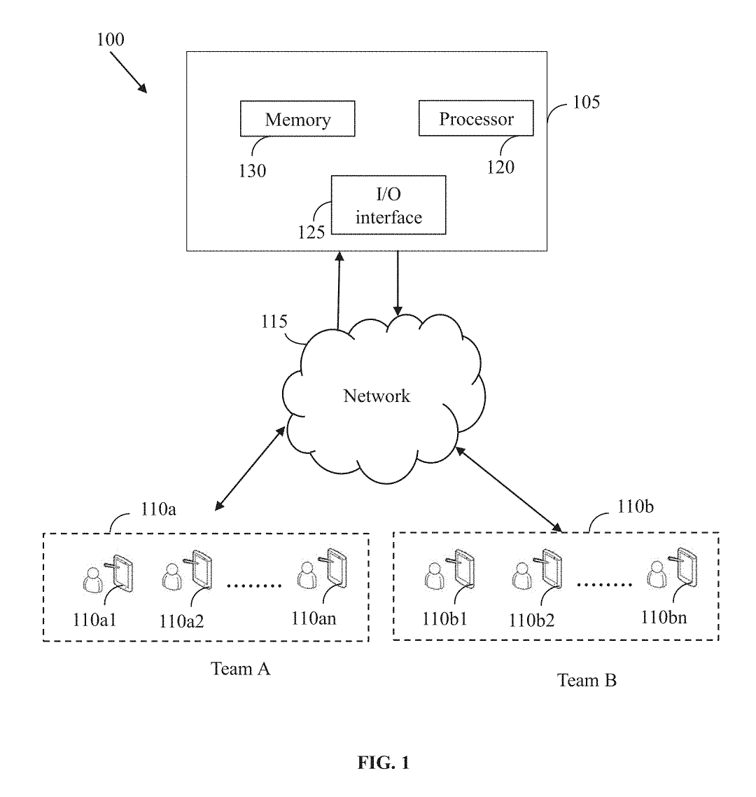

Referring to FIG. 1, an environment 100 of a system 105 for predicting the outcome of a sporting event is illustrated, in accordance with which various embodiments of the invention. Although the present disclosure is explained by considering that the system 105 is implemented on a server, it may be understood that the system 105 may also be implemented in a variety of computing systems, such as a mainframe computer, a network server, cloud, and the like. It will be understood that the system 105 may be accessed by multiple users through one or more user devices 110a and 110b, collectively referred as user devices 110 or applications residing on the user devices 110. Examples of the user devices 110 may include, but are not limited to, a portable computer, a personal digital assistant, a handheld device, and a workstation. The user devices 110 are communicatively coupled to system 105 through a network 115.

In one implementation, the network 115 may be a wireless network, a wired network or a combination thereof. The network 115 can be implemented as one of the different types of networks, such as intranet, local area network (LAN), wide area network (WAN), the internet, and the like. The network 115 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 105 may include at least one processor 120, an input/output (I/O) interface 125, and a memory 130. The at least one processor 120 may be implemented as one or more microprocessors, microcomputers, microcontrollers, digital signal processors, central processing units, state machines, logic circuitries, and/or any devices that manipulate signals based on operational instructions. Among other capabilities, the at least one processor 120 is configured to fetch and execute computer-readable instructions stored in the memory 130.

The I/O interface 125 may include a variety of software and hardware interfaces, for example, a web interface, a graphical user interface, and the like. The I/O interface 125 may allow the system 105 to interact with a user directly or through the user devices 110. Further, the I/O interface 125 may enable the system 105 to communicate with other computing devices, such as web servers and external data servers (not shown). The I/O interface 125 may facilitate multiple communications within a wide variety of networks and protocol types, including wired networks, for example, LAN, cable, etc., and wireless networks, such as WLAN, cellular, or satellite. The I/O interface 125 may include one or more ports for connecting a number of devices to one another or to another server.

The memory 130 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one embodiment of the invention, users of the user devices 110 may access the system 105 via the I/O interface 125. The system 105 is used to bring users in an online platform to engage with one another for predicting an outcome of a sporting event. The sporting event may include, but not limited to, Football, Baseball, Basketball, Hockey, Soccer, Tennis, Golf, Olympic Events, Boxing, Bowling, Darts, Rugby, Cricket, eSports, Mixed Martial Arts, and so on.

In order to engage with one another, at first, each of the users, say a first user may use a first user device 110al. Similarly, the second user may use a second user device 110a2. Similarly, other users may use respective user devices. Specifically, each of the users may register himself/herself with the system 105. In order to register, each user may provide details such as name, address, age, sport in which they are interested, and so on. Further, one or more users may form a team. In one example, consider that the first user, the second user and third user choose to form a first team. The first team may use user device 110a to access the system 105. Similarly, a fourth user may use a fourth user device 110b1, a fifth user may use a fifth user device 110b2 and a sixth user may use a sixth user device 110b6 and form a second team. The second team may use user device 110b to access the system 105.

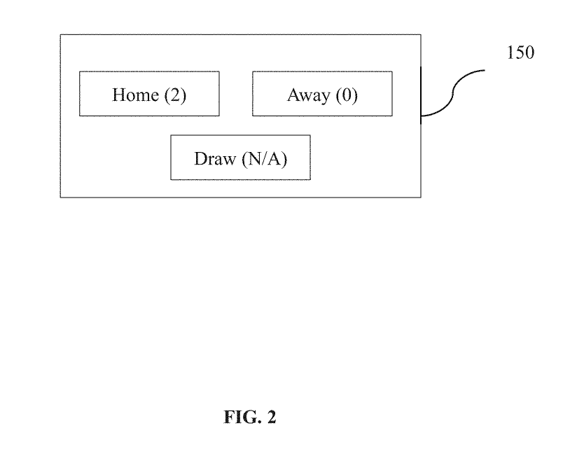

It must be understood that each team may have any number of users and the above example is presented for illustration purposes only. After registering and selecting the team, each of the users is presented with an interface 150 on the user device 110 as shown in FIG. 2. The interface 150 may be presented to select a predicted outcome for the sporting event selected by the users at the time of registering. Considering that the sporting event is a soccer game, the user may be provided with one or more outcomes for the soccer game. As known, any sporting event may have at least two teams say team A and team B playing the sport with an expected outcome of a win for team A (Home team), or a loss for team A (win for Away team), or a draw. The draw indicates both team A and team B have scored an equal number of goals/points as may be applicable for the sporting event. Considering a game of soccer as an example, a win for team A may indicate that team A has scored more goals than team B. Similarly, a loss for team A may indicate that team B scored more goals than team A. Further, a draw may indicate that team A and team B scored equal goals say one goal each by the end of the game. As such, the user is allowed to predict the score that might be scored by the teams playing the game i.e., soccer.

For example, the first user may predict the score indicating that the Home team may score 2 goals and the Away team may score 1 goal, inferring that Home team will win the game. Similarly, each of the users is required to predict the score and the predicted outcome is inferred. It is known that the sporting round or stage such as a weekend of NBA games, or a weekend of English Premier League games comprises a series of events wherein more than two teams compete across various stages. For each stage, the users may be required to predict the score for each game of the stage and infer the predicted outcome.

In one implementation, one or more users may form a team such as a first team, a second team and so on. The number of users in a single team is not limited. In one example, at first, a first user is registered in the first team. The first user may invite other users such as a second user to be part of the first team. Similarly, a third user is registered in the second team. The third user may invite other users such as a fourth user to be part of the second team. The outcome predicted on behalf of a team may be termed as a team consensus prediction. In one example, the team consensus prediction is calculated based on an aggregation of predictions of all members of the team. Similarly, other teams are allowed to make a team consensus prediction.

In each of the first team and the second team, each of the users is allowed to predict the score (and therefore the inferred outcome) of the sporting event. The prediction may be taken in the form of scores or predicted spread for the sporting event. For example, the user may predict that home team may score 3 goals against an away team score of 0. In another example, the user may predict that the home team may win the game by 20 points and so on. After receiving the predicted outcome from each user, the system 105 infers the predicted outcomes i.e., —a score (or score spread), i.e. 3-0, and an outcome/result, i.e. Home Win.

After receiving the predicted outcome from each user, the system 105 analyses the individual predictions for each sporting event E in a stage R. Subsequently, for all the users in the team, say, team A, the system 105 forms the team consensus prediction.

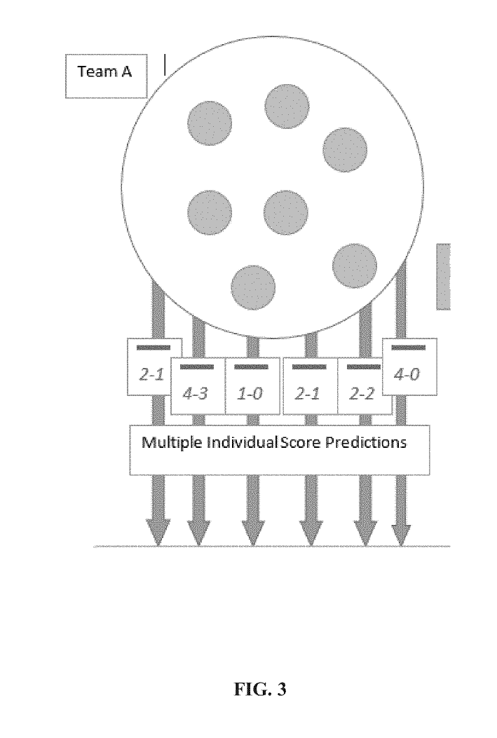

Referring to FIG. 3, team A comprising multiple users, with each user predicting the outcome of the sporting event, is shown. From team A, a first user may predict the outcome as 2-1, a second user may predict the outcome as 4-3, a third user may predict the outcome as 1-0, a fourth user may predict the outcome as 2-1, a fifth user may predict the outcome as 2-2, and the sixth user may predict the outcome as 4-0. Similarly, the predicted outcome from each of the users in other teams comprising other users is received.

After receiving the predicted outcome from each user in different teams, the system 105 calculates the team consensus prediction for each team for the sporting event E. The output from the system (given input of an arbitrary amount of individual predictions for a given event E) is a single consensus prediction P for Event E. For each prediction E, the system 105 a confidence rating to the consensus team prediction based on the number of individual predictions within the team that match the eventual team prediction.

In one embodiment, the system 105 calculates the confidence rating for each team consensus prediction by determining number of individual team members that predicted the same outcome as the eventual consensus prediction P for the event E. The confidence rating is assigned at the same time as the consensus prediction is generated. The confidence rating is represented in the form of a percentage.

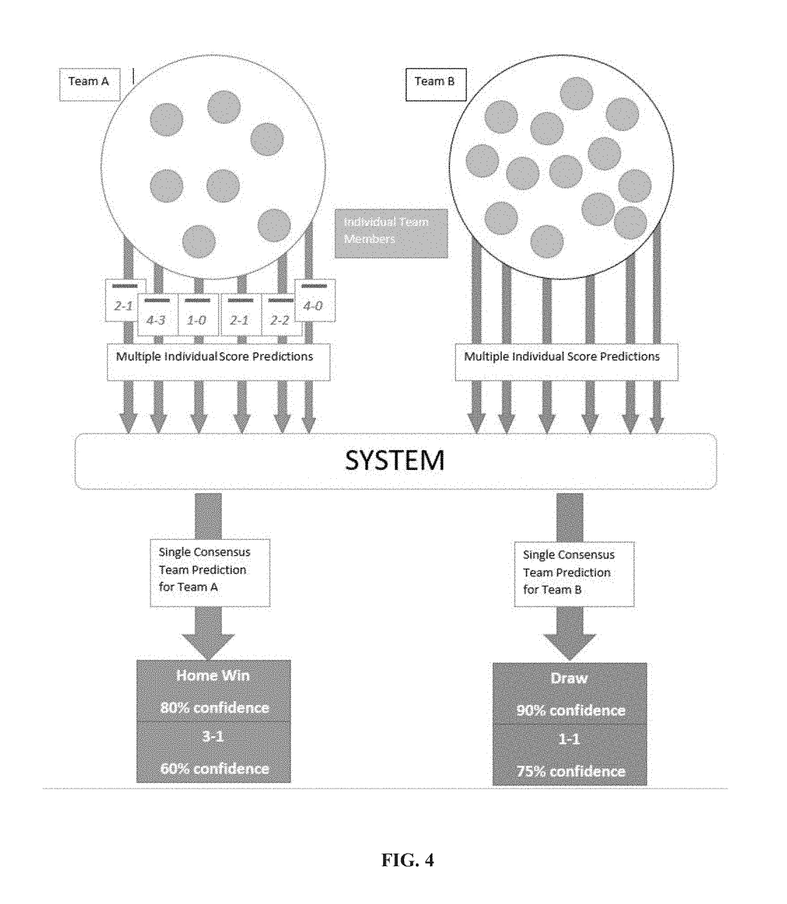

For example, the confidence rating for a team consensus prediction P is expressed as C=(M/T)*100. C indicates confidence in percentage. M indicates the number of predictions made for E by team members, which match the eventual consensus team prediction for that team. T indicates the total number of predictions (correct and incorrect) made by the individual team members of the team for the sporting event E. Referring to FIG. 4, an example illustrating team consensus prediction and calculation of confidence rating is shown, in accordance with one embodiment of the present disclosure.

After the sporting event is finished and the outcome of the sporting event is known, scores are assigned to individual users and also to teams, based on the accuracy of both individual predictions (for the users), and team predictions (for the teams). It is to be understood that the scores are assigned to identify the most accurate and insightful users and teams predicting the eventual outcome.

In one example, the scores are calculated using pre-event odds published for a correct prediction. The odds may be published on newspapers, online and so on. For example, if the odds of a given prediction are 8.5, then a user or team who correctly predicts that outcome will be rewarded 10*8.5=85 points for that prediction. Pre-match odds are used, as they are the most reliable way to reward insightful or unlikely predictions. Similarly, if a user or team correctly makes an extremely unlikely prediction they are rewarded adequately, as the pre-match odds of unlikely predictions will be higher than more obvious predictions. Assigning of the scores based on pre-match odds allows the users and the teams to be rewarded for insightful predictions, and for the system 105 to accurately identify the highest quality users and teams using the system 105.

In one embodiment, points for the users for a given event are derived from multiplying the pre-match odds of a correctly predicted event outcome by 10. Further, points for the user for a given stage are calculated by adding together all points received for correct event predictions in the stage. Similarly, points for a team are calculated in the same manner, but with the addition of a confidence score, which is derived by dividing the confidence rating of a correctly predicted consensus outcome by 10 and adding that number to the points for that event.

In one example, if a user correctly predicts that Arsenal will beat Manchester Utd by 3 goals to nil, and the pre-match odds for that result are (in decimal format) 15.0—then the user will receive 150 (10*15) points for correctly guessing that score, assuming the final score of the actual match is 3 goals to nil. Further, points are received for each correctly predicted result (i.e. Manchester Utd to win) and correctly predicted score (i.e. Arsenal 0-3 Manchester Utd), and added together to give each team member a cumulative point total.

Points are also awarded for correctly predicting the spread (i.e. if the predicted score is inaccurate but the margin of victory is correct). This is calculated from the pre-match odds of a ‘handicap’ wager for that spread. Points for a correct score and a handicap are not awarded for the same prediction

When the scores for each event E are calculated for a given team or user, the scores allocated for each event in the stage are added together to provide a points tally for that stage for the given team/user. The total is used to order teams and user by performance for the given stage (highest score to lowest score) for that stage. This is used to assist in derivation of user and team ranking.

In order to rank the users and the teams, the points awarded at the end of each stage are considered. Specifically, for each stage that the users participate in, the users and the teams are ranked using percentile ranking. The percentile ranking is calculated on a per-team and per-user basis after points are awarded at the end of each stage. For the users, the percentile rankings are assigned only if the user participated in the stage.

In order to determine the user or team ranking, an average of the percentile ranking over all the stages is considered. For example, if a user is ranked in the 90th percentile for 2 stages, then in the 70th percentile for 3 stages, their ranking after 5 stages will be in the 78th percentile. (90+90+70+70+70)/5. The average percentile is considered such that the user participating in more stages will have greater sample data than applying same percentile ranking for all the users.

In one implementation, the system 105 may use the consensus team prediction and the confidence for each event in the stage to produce a customized betslip for each team. Specifically, the system 105 may use the predicted results and confidence assignments to produce a customized betslip for each team. The system 105 may analyze the team predictions and create a series of recommended bets, which the users can use to place wagers with bookmakers operating outside of the system.

In one implementation, the entries in the betslip may comprise of the following outcome types. Result (Home win, Draw, Away Win) with a Score (2-0, 0-0, 1-3 etc). Further, the betslip is determined based on the score prediction, spread, or combined scores of the event. For instance, both teams to score-, To win to nil, score Draw is considered.

The system 105 is used to predict an outcome for a sporting event in a given stage. A stage may consist of multiple sporting events from the same sport, i.e. 6 English Premier League Matches, 8 Major League Baseball matches etc. The stages typically map to a stage in a sporting competition, such as a weekend of matches in the English premier league, a knockout stage in the UEFA champions league, etc. Based on each users' prediction, the system 105 considers the team consensus prediction of the expected outcome for each event in the stage and provides recommendation for wagers.

It should be understood that the system 105 enables individuals engaging in the act of predicting the outcome of sporting event to predict as a group with a single team consensus prediction produced for the outcome of the event. The team consensus prediction is based on an aggregate of the individual predictions of each member. To take part, each team member may simply predict the outcome of a sporting event as they would normally do in any sport prediction product, service or system.

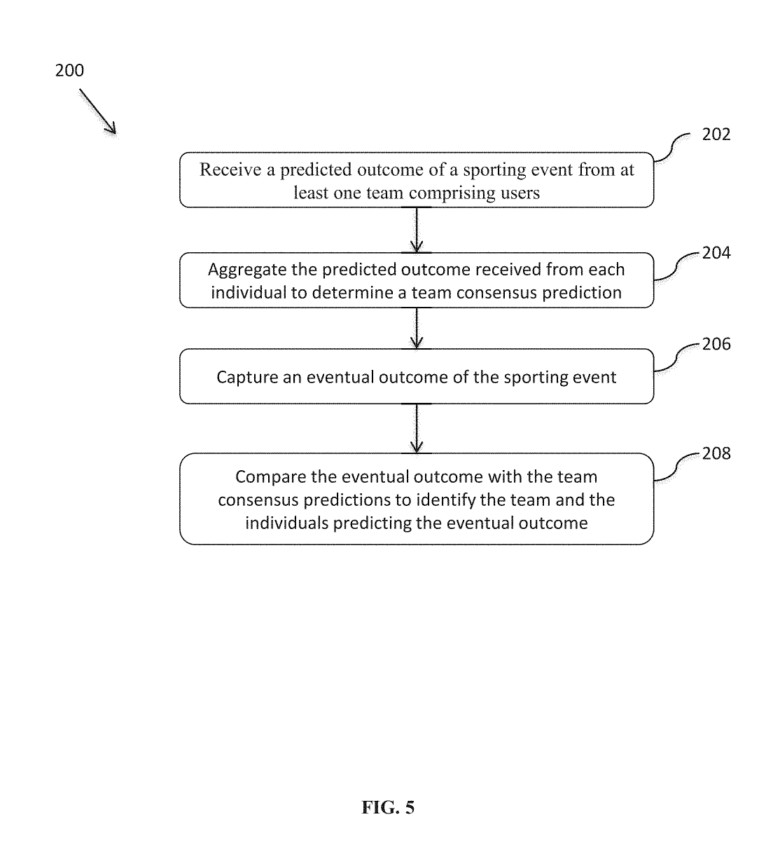

Referring now to FIG. 5, a method 200 for predicting outcome of a sporting event is shown, in accordance with an embodiment of the present disclosure. The method 200 may be described in the general context of computer executable instructions. Generally, computer executable instructions may include routines, programs, objects, components, data structures, procedures, modules, functions, etc., that perform particular functions or implement particular abstract data types. The method 200 may also be practiced in a distributed computing environment where functions are performed by remote processing devices that are linked through a communications network. In a distributed computing environment, computer executable instructions may be located in both local and remote computer storage media, including memory storage devices.

The order in which the method 200 is described and is not intended to be construed as a limitation, and any number of the described method blocks can be combined in any order to implement the method 200 or alternate methods. Additionally, individual blocks may be deleted from the method 200 without departing from the spirit and scope of the disclosure described herein. Furthermore, the method may be implemented in any suitable hardware, software, firmware, or combination thereof. However, for ease of explanation, in the embodiments described below, the method 200 may be implemented in the above-described transaction service platform 105.

At step 202, a predicted outcome of a sporting event from at least one team is received. The team comprises a plurality of individuals, wherein each of the individuals predicts the outcome of the sporting event.

At step 204, the predicted outcome received from each individual in the team is aggregated to determine a team consensus prediction of the outcome of the sporting event.

At step 206, an eventual outcome of the sporting event is captured.

At step 208, the eventual outcome is compared with the team consensus predictions to identify a team predicting the eventual outcome. Similarly, the eventual outcome is compared with the predicted outcome of the individuals to identify the individual predicting the eventual outcome.

Now, the best mode of implementing the disclosure is explained using an example. Consider that there are two teams i.e., team A and team B. Team A may comprise five players such as A, B, C, D and E, and team B may comprise six players such as F, G, H, I, J and K. Consider that each of the players are predicting an outcome of a football game. For team A, consider that each player independently predicts the outcome as shown in Table 1.

Table 1: Team A Players' Prediction

TABLE 1

| | Team | | | | |
|---|---|---|---|---|---|
| | Team A | | | | |
| | Player | | | | |
| | A | B | C | D | E |
| Match 1 | 1-1 | 2-1 | 2-2 | 1-1 | 3-2 |

Similarly, each of the players in team B predicts the outcome of the game as shown in Table 2.

Table 2: Team B Players' Prediction

TABLE 2

| | Team | | | | | |
|---|---|---|---|---|---|---|
| | Team B | | | | | |
| | Player | | | | | |
| | F | G | H | I | J | K |
| Match 1 | 2-2 | 2-3 | 1-1 | 1-3 | 1-4 | 2-3 |

After receiving individual prediction from the players, the system 105 calculates the team consensus prediction. For the above data, the system 105 calculates the team consensus prediction and confidence rating for each match. Referring to Table 3, team consensus prediction of team A is shown.

Table 3: Team A Team Consensus Prediction

TABLE 3

| | Result | Result | Score | Score |
|---|---|---|---|---|
| | prediction | Confidence | prediction | confidence |
| Match 1 | Draw | 60% | 1-1 | 40% |

Similarly, team consensus prediction of team B is calculated as shown in Table 4.

Table 4: Team B Team Consensus Prediction

TABLE 4

| | Result | Result | Score | Score |
|---|---|---|---|---|
| | prediction | Confidence | prediction | confidence |
| Match 1 | Away Win | 67% | 2-3 | 34% |

Further, pre-match score odds are retrieved from an independent, external source. Subsequently, the result, pre-match result odds and pre-match score odds are received, as shown in Table 5.

Table 5: Pre-Match Odds

TABLE 5

| | Result | Pre-Match Result odds | Pre-Match Score Odds |
|---|---|---|---|
| Match 1 | 1-1 | 4 | 12 |

Subsequently, each team member is assigned a score based on the pre-match odds of successful prediction. Referring to Table 6, score assigned for team A players is shown.

Table 6: Team A Score Assignment

TABLE 6

| | Player | | | | |
|---|---|---|---|---|---|
| | A | B | C | D | E |
| Correct result? | Y | N | Y | Y | N |
| Correct Score? | Y | N | N | Y | N |
| Correct Spread? | N/A | N | N/A | N/A | N |
| Match 1: Result Points | 40 | 0 | 40 | 40 | 0 |
| Pre-match result | 4*10 | | | | |
| odds*10 | | | | | |
| Match 1 score points | 120 | 0 | 0 | 120 | 0 |
| formula Odds* 10 | 12*10 | | | | |
| Match 1: Total points | 160 | 0 | 40 | 160 | 0 |

As can be seen from Table 6, Player A and Player D are awarded the most points and therefore jointly win the Team A stage competition, with Player C in second position.

Similarly, a score is assigned to team B players as shown in Table 7.

Table 7: Team B score assignment

TABLE 7

| | Player | | | | | |
|---|---|---|---|---|---|---|
| | F | G | H | I | J | K |
| Correct result? | Y | N | Y | N | N | N |
| Correct Score? | N | N | Y | N | N | N |
| Correct Spread? | N/A | N | N/A | N | N | N |
| Match 1: Result Points | 40 | 0 | 40 | 0 | 0 | 0 |
| Pre-match result | 4*10 | | | | | |
| odds*10 | | | | | | |
| Match 1 score points | 0 | 0 | 120 | 0 | 0 | 0 |
| formula Odds*10 | 12*10 | | | | | |
| Match 1: Total points | 40 | 0 | 160 | 0 | 0 | 0 |

As can be seen from Table 7, Player H is awarded the most points and therefore wins the Team B competition for the given stage.

Further, the teams are allocated scores for each match based on the outcome of the match (in-game phase) compared to the consensus prediction generated by the team in the consensus phase. Referring to Table 8, points calculated for team A are shown.

Table 8: Team A Point Calculation

TABLE 8

| | Team A |
|---|---|
| Correct result? | Y |
| Correct Score? | Y |
| Correct Handicap? | N/A |
| Match 1: Result Points | 46 |
| Pre-match result | 4*10 + 6 |
| odds*10 + resultcont/10 | |
| Match 1 score points | 124 |
| formula Odds* 10 + score | 12*10 + 4 |
| confidence/10 | |
| Match 1: Total points | 170 |

Similarly, points are calculated for team B as shown in Table 9.

Table 9: Team B point calculation

TABLE 9

| | Team B |
|---|---|
| Correct result? | N |
| Correct Score? | N |
| Correct Handicap? | N/A |
| Match 1: Result Points | 0 |
| Pre-match result | |
| odds*10 + resultcont/10 | |
| Match 1 score points | 0 |
| formula Odds* 10 + score | |
| confidence/10 | |
| Match 1: Total points | 0 |

It should be understood that Team A is awarded 170 points based on an accurate consensus prediction and therefore wins a Team v Team Competition against Team B (awarded 0 points).

Furthermore, Players and teams are ranked based on their relative performances. there were 6 games in the stage, each scored in the same manner as above, to give total scores for the stage as above.

Table 10: Team A Players Ranking

TABLE 10

| | Player | | | | |
|---|---|---|---|---|---|
| | A | B | C | D | E |
| Total Stage Score | 460 | 321 | 96 | 740 | 121 |
| Percentile ranking | 64 | 55 | 9 | 82 | 27 |
| Ranking order for | 4th | 5th | 10th | 2nd | 9th |
| stage | | | | | |

Similarly, team B players ranking is determined as shown in Table 11.

Table 11: Team B Players Ranking

TABLE 11

| | Player | | | | | |
|---|---|---|---|---|---|---|
| | F | G | H | I | J | K |
| Total Stage Score | 25 | 792 | 608 | 97 | 234 | 280 |
| Percentile ranking | 0 | 91 | 73 | 18 | 36 | 45 |
| Ranking order for | 11th | 1st | 3rd | 8th | 7th | 6th |
| stage | | | | | | |

It should be understood that the above example is provided for illustrative purposes only and should not be construed in a limited sense. The system 105 may be used to predict the outcome of a sporting event when one or more teams are involved. Each team may include two or more players. Based on each team member's prediction, the team consensus prediction is calculated, and the predicted outcome is compared with the eventual outcome of the event.

Although embodiments of predicting the outcome of a sporting event have been described in language specific to features and/or methods, it is to be understood that the description is not necessarily limited to the specific features or methods described. Rather, the specific features and methods are disclosed as examples of implementations of predicting the outcome of a sporting event as a team or group.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A method of predicting the outcome of a sporting event, the method comprising:
receiving, by a processor, a predicted outcome of a sporting event from at least one team, wherein the team comprises a plurality of individuals, wherein each of the individuals predict the outcome of the sporting event;
aggregating, by the processor, the predicted outcome received from each individual in the team to determine a team consensus prediction of the outcome of the sporting event;
capturing, by the processor, an eventual outcome of the sporting event; and
comparing, by the processor, the eventual outcome with the team consensus predictions to identify the team and the individuals predicting the eventual outcome.

2. The method of claim 1, wherein the team consensus prediction comprises the predicted outcome and a confidence rating.

3. The method of claim 2, wherein the confidence rating is determined using a percentage of the individuals on the team predicting the eventual outcome accurately.

4. The method of claim 1, wherein the sporting event comprises a plurality of stages.

5. The method of claim 4, wherein the predicted outcome is received for each event in of the stage from each of the individuals and the teams.

6. The method of claim 5, further comprises determining a score for each event in a stage for the predicted outcome received.

7. The method of claim 6, wherein the score is determined for the individuals based on the predicted outcome compared against the eventual outcome of the sporting event.

8. The method of claim 6, wherein the score is determined for the team based on the team consensus prediction against the eventual outcome of the sporting event.

9. The method of claim 6, further comprising ranking the individual and the team based on the predicted outcome and the team consensus prediction respectively against the eventual outcome.

10. A system for predicting the outcome of a sporting event, the system comprising:
a memory; and
a processor coupled to the memory, wherein the processor is configured to execute program instructions stored in the memory, to:
receive a predicted outcome of a sporting event from at least one team, wherein the team comprises a plurality of individuals, wherein each of the individuals predicts the outcome of the sporting event;
aggregate the predicted outcome received from each individual in the team to determine a team consensus prediction of the outcome of the sporting event;
capture an eventual outcome of the sporting event; and
compare the eventual outcome with the team consensus predictions to determine the team and individuals predicting the eventual outcome.

11. The system of claim 10, wherein the team consensus prediction comprises the predicted outcome and a confidence rating.

12. The system of claim 10, wherein the confidence rating is determined using a percentage of the individuals predicting the eventual outcome accurately.

13. The system of claim 10, wherein the sporting event comprises a plurality of stages.

14. The system of claim 10, wherein the predicted outcome is received for each event of the stage from each of the individuals and the teams.

15. The system of claim 10, wherein a score for each event of the stage for the predicted outcome received is determined.

16. The system of claim 15, wherein the score is determined for the individuals based on the predicted outcome compared against the eventual outcome of the sporting event.

17. The system of claim 15, wherein the score is determined for the teams based on the team consensus prediction compared against the eventual outcome of the sporting event.

18. The system of claim 15, wherein the individual and the teams are rated based on the predicted outcome and the team consensus prediction respectively against the eventual outcome.
